(19) United States
(12) Patent Application Publication
(10) Pub. No.: US 2012/0200402 A1
(43) Pub. Date: Aug. 9, 2012

(54) SELF-POWERING BICYCLE BRAKE SIGNAL SYSTEM

(76) Inventor: JARED LOVELESS, Greenport, NY (US)

(21) Appl. No.: 13/365,338

(22) Filed: Feb. 3, 2012

Related U.S. Application Data
(60) Provisional application No. 61/439,611, filed on Feb. 4, 2011.

(51) Int. Cl. B62J 6/00

(52) U.S. Cl. 340/432

(57) ABSTRACT

The present invention relates to providing a safe, reliable bicycle brake signal that generates its own power in response to brake actuation, in order to provide an alternative to hand signals or no signals at all for the bicycling public. This is done by producing the energy for a noticeable warning light using a friction-driven dynamo(s) at a time when the bicycle rider won't notice the additional drag on forward momentum caused by such devices. This will create a safer experience for group riders of bicycles and bicycle commuters.

### FIELD OF THE INVENTION

This application claims priority to U.S. Provisional Application Ser. No. 61/439,611, filed Feb. 4, 2011, which is incorporated by reference herein (including drawings). The invention relates to a bicycle brake signal system, which is self-powering and is actuated by the braking of the bicycle.

### BACKGROUND OF THE INVENTION

The present invention relates to brake signals for bicycles, and more particularly, to a bicycle brake signal assembly detachably securable to a bicycle.

The conventional bicycle, while commonly outfitted with a taillight is generally lacking in a stop signal—that is a bright rear warning light in addition to the taillight, which is energized only upon the actuation of the brakes. Automobiles started out without signals, but eventually signals became necessary, which is what is happening now with bicycles due to the implementation of bike lanes in many major metropolitan areas, and the ever-increasing amount of bicycle commuters in any given community. Many brake light systems have heretofore been proposed but all have required the use of switches and/or batteries, and have been complicated and/or unreliable.

Bicycle riders are also tasked with using a set of hand signals to alert others around them of their intentions, whether it be turning left or right, or slowing down. These signals are all done with the left hand. This means a bicycle rider can't signal that they are slowing and turning simultaneously, and it means that a bicycle rider that needs to stop or slow down has to do it with only one hand on the handle bars for balance which creates a dangerous situation as the rider is forced to choose between signaling and holding on tight. The present invention aims to improve the way a bicycle rider signals to those around them of their intent to stop by creating a real-time brake signal that is triggered by use of the brakes, rather than a hand signal. This allows the rider to use both hands to control said bicycle during braking, or to perform a hand signal for turning, while the brake signal alerts others to the braking of the bicycle.

Other patents have addressed the issue of creating a switch for a brake light such as U.S. Pat. No. 4,031,343 to Sopko and U.S. Pat. No. 3,188,418 to Pino, but switches like these only form a small part of a brake signal system and neither item is designed to supply power, while each item is susceptible to being a point of failure in the signal loop. Beyond that each item relies on a separate power source and light as well as the associate link between them, meaning that the chances of malfunction are increased with each component. Likewise, patents like U.S. Pat. No. 5,895,991 to Butz refer to power generation but in a continuous manner that requires user engagement prior to each use and derives power from the pedaling rider and not the already spinning wheel. This requires the user to engage the item in order to utilize the benefits, but then can only realize those benefits by trading performance. Also, U.S. Pat. No. 5,634,533 to Zago relates to a braking device that is installed on motorcycles and bicycles to offer anti-lock capabilities to help control the vehicle during braking, with a “complex” version containing, in addition, a generator (Not Shown) used to signal braking action with a signal light (Not Shown).

This concept involves installing the entire complex version of the device in place of the existing brakes, pointedly most beneficial on the front wheel as per Zago, and presumably not both due to the intermittent braking, which due to the fact that the eccentric gear wheel must remain in contact with the piston that intermittently pushes the brake pad against the rim, causes an intermittent reactionary push back on the gear wheel that would be intermittently transferred back to the user through the brake cable as a shimmy or stutter in the brake lever. To that effect the stutter of this device on the front and rear wheel combined would be much worse when each piston was thrusting simultaneously without being able to coordinate when each brake pad would contact the corresponding wheel surface.

Similarly, if the pressure put on the eccentric gear wheel causes greater friction than the knurled wheel can exert on the tire sidewall the knurled wheel would not spin and would not work for the anti-lock mechanism and would not work for the generator and could possibly cause tire failure as well as possibly not being able to apply enough force to the brake pad to effectively brake the bicycle or motorcycle. Combining the anti-lock mechanism and the generator in the same device as in the complex version mentioned by Zago, increases the likeliness of a malfunction in some part of the device decreasing the reliability of the system overall including the very essential brakes themselves, and to make the device less complex by removing the anti-lock mechanism would render the brakes and the additional generator useless.

### SUMMARY OF THE INVENTION

It is therefore a principle object of the present invention to provide an improved bicycle accessory.

Another object of the present invention is to provide an improved bicycle brake signal system.

Yet another object of the present invention is to provide an improved mechanism for energizing a bicycle brake signal incidental to the braking of the bicycle.

And yet another object of the present invention is to provide an improved bicycle brake signal energizing mechanism, which is actuated in response to the application of the bicycle brake.

One more object of the present invention is to provide a system of the above nature characterized by its portability from one bicycle to another, as well as tool-less installation, low maintenance, and reliability.

The above objects, along with other objects of the present invention will present themselves through a reading of the following description and viewing the accompanying pictures which illustrate a preferred embodiment.

In the preferred embodiment of the present invention, the bicycle brake signal system includes a manually detachable pod which houses a mechanism for energizing a bicycle brake signal along with a corresponding light that, when energized by said mechanism, warns or signals following drivers/riders to the act of braking by the bicycle equipped with said brake signal system. The manually detachable pod is designed to interlock with the available brake appendages in order to move in tandem with said brakes, supplying energy to the aforementioned light when the user engages the brakes in order to stop or slow the bicycle down. The mechanism for energizing the bicycle brake signal system can be a wheel dynamo designed to spin against the wheel or rim of the bicycle in such a manner that the force is directed downwards and forwards, pushing the housing pod against the brake appendage preventing the detachable unit from becoming dislodged during use. While this wheel dynamo is designed to move towards the wheel or rim during braking creating an “on” condition, it is similarly designed to retract along with the brake appendage creating an “off” condition. For this reason, the present invention does not require a switch in order to activate the light, meaning there is one less point where failure or malfunction could occur. Being that the reason for the dynamo in the system is to provide electricity, the present invention also does not require batteries, which eliminates yet another point of potential malfunction. With no switch and no need for storing energy, the present invention is inherently more efficient and reliable than a system that utilizes a switch and/or an energy storage system.

It is understood by those with knowledge in the field that the pod and/or the signal light could very easily be built into existing parts of the bike such as brake calipers and seat posts, negating the need for the user to have to install them. The housing pod is also suitable for adaptation to work with coaster brakes, which are activated by using the feet in reversing the direction the bicycle crank and drive chain are turning, allowing for installation on a large percentage of children's bicycles increasing the effectiveness of a brake signal suitable for small children and adults with coaster brakes. Similarly, it is understood that this system could be adapted to be used with disc or drum brakes as well.

### BRIEF DESCRIPTION OF THE DRAWINGS

FIG. 1 is a series of exploded views illustrating an example of how the housing pod for the bicycle brake signal mechanism could be configured.

FIG. 2 is a left view showing an example of the bicycle brake signal system mounted on a bicycle brake caliper.

FIG. 3 is a right view depicting an example of the bicycle brake signal system integrated directly into a brake caliper.

FIG. 4 depicts another example of the bicycle brake system integrated into a brake caliper.

### DESCRIPTION OF THE PREFERRED EMBODIMENT

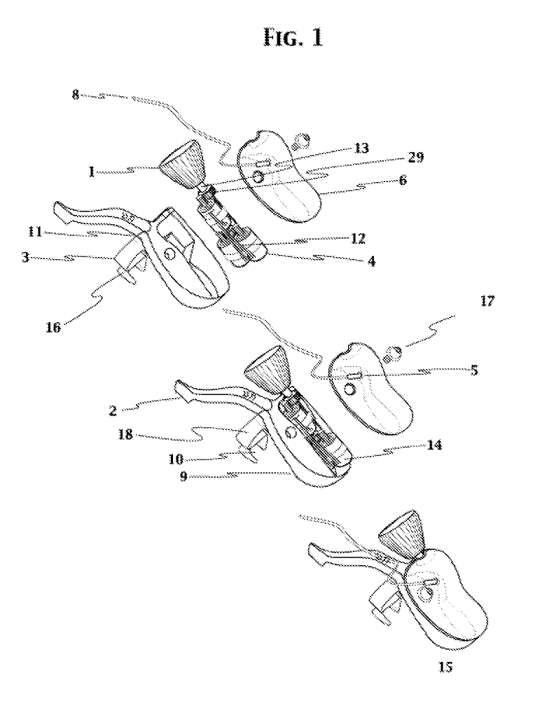

Referring now to FIG. 1 there is shown a series of exploded views depicting an example of how the pod 15 that houses the mechanism 4 that provides energy to the bicycle brake signal system could be configured. This includes having a two-piece construction consisting of a top piece 6 and a bottom piece 9. The two pieces can create a hollow housing pod that can be temporarily joined by way of a reusable means such as a bolt 17 that can be utilized in reverse to separate the two pieces for repairs or maintenance. Likewise, they could snap together or use another means of temporary joinery.

As used herein, the term brake caliper 30 refers to the portion of a bicycle brake system that acts as a lever to push the brake pad 34 against the rim 25 of the bicycle wheel 32. This lever, or brake caliper 30, is attached to a mounting post 33 or rod on the bicycle frame that creates a pivot point for the lever allowing it to be manipulated by a cable connected to a corresponding hand lever on the bicycle handlebars—pulling the hand lever results in the brake caliper 30 pivoting on the bicycle frame towards the rim 25 of the wheel 32 so the attached brake pad 34 is able to contact said rim 25 causing friction which slows the bicycle.

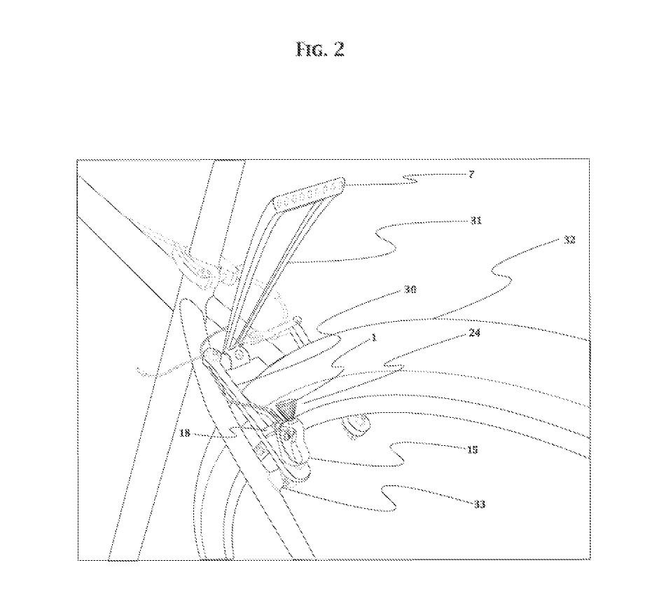

As used herein, the term mechanism 4 refers to a configuration consisting of a dynamo or multiple dynamos arranged in a manner that allows a spinning rod or axle to rotate a gear system connected to the rotor of the dynamo or dynamos. The mechanism 4 could consist of one or more dynamos 14 that are connected by wires 12 to a jack 5 for a plug. The plug connects to a light 7, as seen in FIG. 2, which is the signal portion of the bicycle brake signal system. This light 7 can be mounted on a stem or bracket 31 or the bicycle seat post, for example, in order to raise the lights higher to increase visibility. The two pieces of the pod 15 when connected by the bolt 17 are supported on the bicycle brake caliper by a band of metal 18 that extends downwards, changing directions repeatedly creating a series of bends 3 that create a relief 16 to accommodate the brake caliper. These bends result in final surface which is parallel to the underside of the bottom piece 9 of the pod 15 that has a semicircle opening 10 where the pod engages the brake caliper mounting post or brake shoe post on a bicycle, allowing the pod 15 to share the same pivot-point as the brake caliper 30. This semicircle opening 10 is positioned with the mouth facing towards the ground and the pod 15 parallel with the brake caliper 30, which results in the pod 15 being oriented on the topside of the brake caliper 30 allowing the forward spinning wheel 32 of the bicycle to exert force in a manner that pushes the pod 15 against the brake caliper 30, negating the need for other forms of mechanical attachment between the pod 15 and the brake caliper 30. The band 18 that supports the pod 15 can be designed to rotate 360 degrees so that the orientation of the pod 15 in relation to the semicircle opening 10 can be adjusted for different types of available brake systems for bicycles

Mounted on the top end of the bottom piece 9 of the pod 15 is an extended armature 2 that acts to create leverage for the brake caliper to move the pod 15 towards the bicycle wheel 32, rim 24 or tire 25, during brake use. This armature 2, like the band 18, can be designed to rotate as necessary in order to accommodate different types of bicycle brake systems. The armature 2 can be adjusted with a finger wheel 11, not shown, so that it contacts the bicycle wheel 32 in the optimal position, which is slightly ahead of the brake pad 34 allowing an initial burst of full speed thrust from the wheel 32 prior to the braking process. The contact between the bicycle wheel 32 and the drive wheel 1 during braking causes the dynamos 14 to spin, creating electricity which flows through a wire 8 to a signal light 7 creating a real-time brake signal for the bicycle as it brakes. When the rider of the bicycle disengages the brakes the brake caliper 30 moves away from the wheel 32 along with the pod 15 and the brake signal diminishes along with the electrical current. The dynamos 14 can be powered by a driveshaft 13, which is connected to a drive wheel 1 and a set of gears 29 that move when in contact with a spinning bicycle wheel 32. Other methods of transferring the force from the bicycle wheel 32 to the dynamos 14 may exist and could be developed in the future. This automatic generation of power that occurs during and as a direct result of braking, means that there is no need to have power storage unit built into the bicycle brake signal system. However, should the desire to have a continuous blinking light or taillight built into the light 7 then a separate power source could be built in to accommodate that function. This would still limit the need to have any switches or circuitry in order to produce a reliable bicycle brake signal.

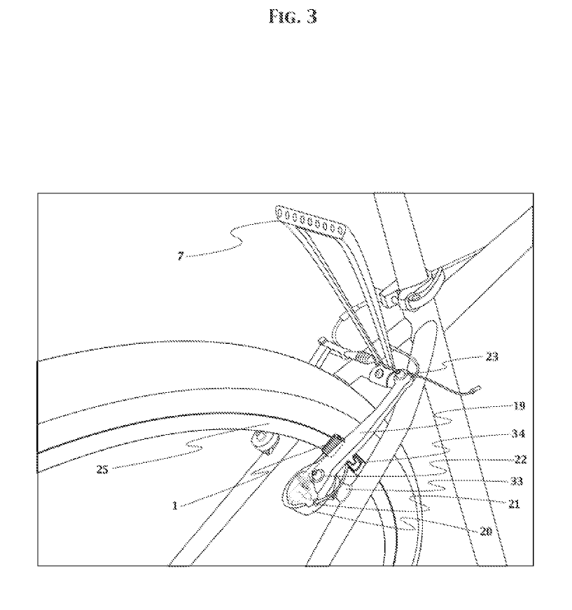

Referring now to FIG. 3 which depicts an example of how the bicycle brake signal system could be built into the brake caliper 30 of a bicycle, it is assumed that some people will want to have the brake signal system on their bicycle without requiring it to be easily portable. This can be achieved the most efficiently by building the mechanism that powers the brake signal system right into the caliper 30 or calipers of a bicycle. The brake caliper 30 would have to consist of two pieces as to allow for a hollow area within which would house the dynamos 14 . These two pieces can be temporarily joined by friction or other means when pushed together. In the installed position the top portion 19 and the bottom portion 20 can be held securely together by the bolt 22 that connects the caliper to the bicycle frame and the bolt 23 that secures the brake cable to the brake caliper. This assures that the top 19 and bottom 20 portions will remain together during use of the bicycle brakes. The brake caliper 30 could connect to the light via a plug jack 21 designed to accept a wire from the light 7. Along the same lines, the light 7 could be configured or designed to be attached or built into the brake caliper 30 as well, effectively making the unit self contained in the brake system of the bicycle. This method of design having the position of the drive wheel 1 directly related to the position of the brake caliper 30 may eliminate the need for adjusting the position of the drive wheel 1 in order to achieve the optimized position. Another benefit of this configuration is further reducing the number of points of failure in the bicycle brake signal system.

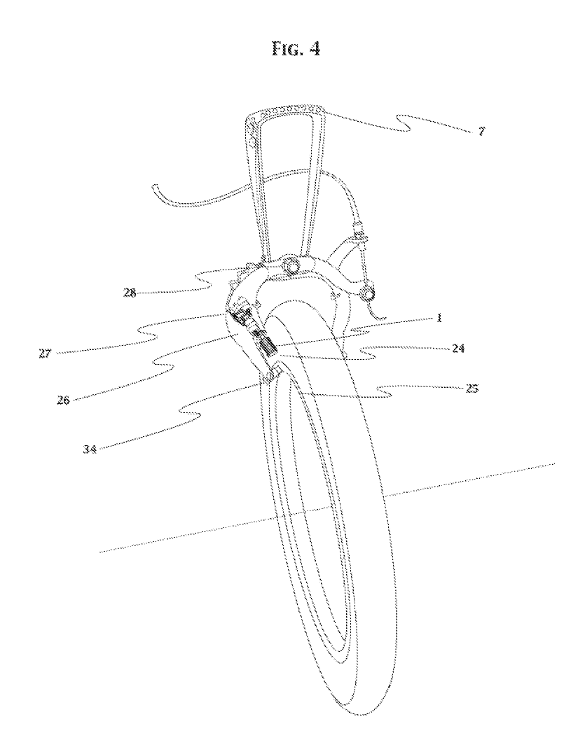

FIG. 4 depicts a second example of how the bicycle brake signal system could be integrated into the brake caliper. It is understood that each type of brake system needs different considerations when being built directly into the brake caliper or other dedicated part of the brake system. For example the bolt 28 that holds the brake calipers 26 on the bicycle frame can also be used to hold the stem 21 of the light 7 so as not to take from existing needs of the brake system.

While there has been described and illustrated a preferred embodiment of the present invention, it is easily understood and recognized that there are numerous alterations, omissions and additions that may be made without departing from the spirit of the present invention thereof. An example is that the bicycle brake signal system while most useful on the rear of the bicycle could also be utilized on the front of the bicycle or both the front and rear. Another example would be to use the same principle with sound, where a motor compresses air and blows a whistle with or without the signal light.

I claim:

1. A bicycle brake signal system that does not rely on switches or batteries in order to reliably create a brake signal for a braking bicycle with said brake signal system utilizing existing actions and forces already required for braking a bicycle resulting in no increase of exertion by user or decrease in bicycle performance.

2. Said brake signal system from claim 1 comprising:
a housing pod containing a mechanism that produces energy needed to power a brake signal light;
said mechanism located inside the housing pod consisting of a dynamo or dynamos that are wheel driven;
a drive wheel that is mounted on a drive shaft to power dynamo(s);
a gear system to transfer the force from the drive shaft to the dynamo(s);
a means of transferring the power being generated to a light source such as wires;
a warning light that acts as bicycle brake signal; and
a stem or post to mount said light higher off the ground for increased visibility.

3. The bicycle brake signal system from claim 2 further comprising and configured of an armature attached to and extending away from the housing pod for leverage to move the pod, and a saddle, strap or other means of mounting attached to the housing pod for mounting said pod on the existing brake system or frame of a fully assembled bicycle.

4. The bicycle brake signal system from claim 3 which, due to the nature of the forces applied to housing pod during use, is able to utilize connections that easily attach the housing pod to the existing bicycle brake caliper(s) and can rely on the forces from the spinning wheel to push the pod into the seated position against the brake caliper negating the need for substantial mounting hardware, making it possible for the average user to install the bicycle brake system on a fully assembled bicycle without the use of tools and without the fear of the unit becoming dislodged during use.

5. The bicycle brake signal system from claim 1 wherein the signal system is fully or partially integrated into any variety of existing bicycle brake systems, effectively incorporating the bicycle brake system and the bicycle brake signal system allowing the pod to be built directly into one or both of any variety of brake calipers along with the signal light.

6. The bicycle brake signal system from claim 5 where the signal light is incorporated into a different part of the bicycle such as the seat post or seat.

7. The bicycle brake signal system from claims 1, 2, 3, 4, 5 and 6 wherein the warning light of the bicycle brake signal is coupled with a taillight that acts as a full-time visibility instrument wherein said taillight would be powered by a separate source such as batteries and would be switchable, limiting the need for a large variety of components that compliment each other to take up limited space on a bicycle.
